(19) United States
(12) Patent Application Publication
(10) Pub. No.: US 2005/0050347 A1
(43) Pub. Date: Mar. 3, 2005

(54) System, method and chip for hardware detection of illegal software user, computer system having hardware detection chip thereof and a software registration center

(76) Inventor: Min-Chih Hsuan, Hsinchu (TW)

Correspondence Address: J C PATENTS, INC., 4 VENTURE, SUITE 250, IRVINE, CA, 92618, US

(21) Appl. No.: 10/666,802

(22) Filed: Sep. 17, 2003

(30) Foreign Application Priority Data
Sep. 3, 2003 (TW) 92124297

(51) Int. Cl. G06F 11/30

(52) U.S. Cl. 713/200

(57) ABSTRACT

A software copyright protection system, method, chip and peripheral subsystem is provided. In one aspect of this invention, a smart security identity (SID) integrated circuit (IC) is used for registering a legal user. To become an authorized users of a particular software program, a software serial number and a communication equipment serial number must be submitted to the smart SID IC in a registration process to obtain a legal inspection code. The smart SID IC not only serves as a hardware serial number built-in module, but also reports to the software producer any illegal software registration attempts.

### CROSS-REFERENCE TO RELATED APPLICATION

This application claims the priority benefit of Taiwan application serial no. 92124297, filed Sep. 3, 2003.

### BACKGROUND OF THE INVENTION

1. Field of Invention

The present invention relates to a method of detecting illegal software loading. More particularly, the present invention relates to a method of using a hardware integrated circuit device design to detect any illegal attempt at loading software.

2. Description of Related Art

Among a variety of conventional methods for software copyright protection, the most common is a serial number (S/N) registering method. The simplest method is to store a few serial numbers or registering codes within one or a few files when the software vendor issues a software. Since a user is able to secure the software serial number attached by the software vendor after a purchase, the users are free to install the software into their computer and then register with the software vendor using the serial number provided. Alternatively, or the serial number is sent to the software vendor in return for a register code. After checking the consistency of the input serial number and register code with the one in the file holding the software serial numbers and register codes, the user is legally permitted to use the software. However, this registering method has one major drawback. Through the serial numbers and the register codes, a user may install the software on different computers of which some are illegal.

To bridge the security gap, some software vendors attach a hardware protective lock (a key-pro) to each package of published software. Aside from installing the software into the computer, a user is requested to connect the key-pro to an interface card connection port such as a printer port. Thereafter, the user must register using the software serial number and the register code provided to become a legal user. One major drawback for this registering method is the additional cost of providing the key-pro. Furthermore, if the software vendors demand a key-pro for each of their products, the computer may run out of space for accommodating such hardware. Moreover, sophisticated user may break up the key-pro and replicate so that the software can be illegally installed in different computers and back to the aforementioned situation again.

After the popularity of Internet, each software vendor now has an Internet address that can be reached for registration. At the networking address, a large file holding information relating to serial numbers and registration codes resides. After purchasing a particular software product from a vendor and installing the software into a computer, the user must submit the attached serial number as well as some personal user ID such as the e-mail address via the Internet to the vendor to obtain a register code. On checking the validity of the register code and serial number sent to the Internet address, the serial number, the user ID and the register code are stored in a file in the address and then the user is confirmed as a legal user. Yet, the same critical drawback still lurks behind this scheme, namely, the software can still be installed in different computers for illegal use via the serial number, the user ID and the register code.

### SUMMARY OF THE INVENTION

Accordingly, one object of the present invention is to provide a system, method and chip for hardware detection of illegal user, a computer system having a hardware detection chip thereof and a registration center capable of preventing anyone from illegally using a software before receiving full authorization.

A second object of this invention is to provide a system, method and chip for hardware detection of illegal user, a computer system having a hardware detection chip thereof and a registration center capable of protecting the intellectual property right of a software vendor. The intellectual property right can be protected because any illegal use of software is immediately reported back to the software vendor.

To achieve these and other advantages and in accordance with the purpose of the invention, as embodied and broadly described herein, the invention provides an illegal software download detection system implemented on hardware. The illegal software download detection system is adapted to any type of software that needs to be downloaded into a computer and demands the input of a software serial number. The system at least includes a personal identity circuit and a communication control interface. The personal identity circuit holds a software serial number and generates a corresponding inspection code when the software needs to be installed. The communication control interface has a communication equipment number for connecting the personal identity circuit to a new product registration center. According to the software serial number and the communication equipment number, the new product registration center resets the inspection code. Before the computer is able to execute the software program, the program will first check the inspection code. If the inspection code is set to a legal user state, program execution is continued. On the other hand, if the inspection code is found to be in an illegal user state, program execution is immediately terminated.

In the aforementioned embodiment, the personal identity circuit is a smart security-ID (SID) integrated circuit (IC). To obtain legal permission for using the software, a user has to use the software serial number for registering with the smart security-ID integrated circuit. The smart security-ID integrated circuit can also be a serial number built-in module.

Preferably, the aforementioned new product registration center further includes a database. The database includes a plurality of datasets. When the new product registration center receives a software serial number and a communication equipment number, the serial number and the communication equipment number will be compared with the datasets in the database. If a software serial number and a communication equipment number identical to the submitted serial number and communication equipment number are not found within the database, a new dataset corresponding to the software serial number and the communication equipment number is written into the database. Thereafter, the inspection code is reset to a legal user state. The new product registration center is connected to a software manufacturer system. After the new product registration center has reset the inspection code to a legal user state according to the software serial number and the communication equipment number, the fact that the software has been registered is immediately reported back to the software manufacturer system. If the software serial number is found in the database but the communication equipment number differs from the corresponding communication equipment number in the dataset, the inspection code is reset to an illegal user state.

In the aforementioned embodiment, the communication control interface comprises a network interface card, a wireless communication network or a global positioning system.

In the aforementioned embodiment, the new product registration center can be connected to a software manufacturer system. After the new product registration center has reset the inspection code to a legal user state according to the software serial number and the communication equipment number, the fact that the software has been registered is immediately reported back to the software manufacturer system.

Preferably, the aforementioned personal identity circuit comprises a microprocessor, a non-volatile memory unit and a media access controller. The microprocessor has a memory for generating the inspection code in the process of installing the software into a computer. The non-volatile memory unit is coupled to the microprocessor for holding the inspection code. The media access controller is coupled to the non-volatile memory unit and the communication control interface for transmitting the inspection code to the new product registration center via the communication control interface.

The aforementioned memory can be an erasable programmable read-only-memory (EPROM), an electrically erasable programmable read-only-memory (EEPROM), a flash memory, a static random access memory (SRAM) or dynamic random access memory (DRAM).

The aforementioned non-volatile memory unit can be an erasable programmable read-only-memory (EPROM), an electrically erasable programmable read-only-memory (EEPROM) or a flash memory.

In another embodiment, the aforementioned personal identity circuit comprises a microprocessor, a non-volatile memory unit and a media access controller. The microprocessor is used for generating the inspection code in the process of installing the software in a computer. The non-volatile memory unit is coupled to the microprocessor for holding the inspection code. The media access controller is coupled to the non-volatile memory unit and the communication control interface for transmitting the inspection code to the new product registration center via the communication control interface.

This invention also provides a chip inside a system adapted to detecting an illegal loading of any software having a software serial number. The system is suitable for installing the software into a computer and executing the software thereafter. The chip includes a microprocessor, a non-volatile memory unit and a media access controller. The microprocessor is used for generating the inspection code in the process of installing the software in a computer. The non-volatile memory unit is coupled to the microprocessor for holding the inspection code. The media access controller is coupled to the non-volatile memory unit and the communication control interface for transmitting the inspection code to the new product registration center via the communication control interface. According to the software serial number and the communication equipment number, the new product registration center resets the inspection code. Before the computer is able to execute the software program, the program will first check the inspection code. If the inspection code is set to a legal user state, program execution is continued. On the other hand, if the inspection code is found to be in an illegal user state, program execution is immediately terminated.

In the aforementioned embodiment, the communication control interface includes a network interface card, a wireless communication network or a global positioning system.

The aforementioned non-volatile memory unit can be an erasable programmable read-only-memory (EPROM), an electrically erasable programmable read-only-memory (EEPROM) or a flash memory.

This invention also provides a method of hardware detecting any illegal loading of software suitable for installing software having a software serial number into a computer and executing the software thereafter. The method includes the following steps. First, the software serial number is stored and then a corresponding inspection code is generated in the process of installing the software into a computer. The inspection code and a communication equipment serial number of the computer are transmitted to a new product registration center. According to the software serial number and the communication equipment serial number, the new product registration center resets the inspection code. Before the computer is able to execute the software program, the program will first check the inspection code. If the inspection code is set to a legal user state, program execution is continued. On the other hand, if the inspection code is found to be in an illegal user state, program execution is immediately terminated.

The aforementioned new product registration center further comprises a database. The database includes a plurality of datasets. When the new product registration center receives a software serial number and a communication equipment number, the serial number and the communication equipment number will be compared with the datasets in the database. If a software serial number and a communication equipment number identical to the submitted serial number and communication equipment number are not found within the database, a new dataset corresponding to the software serial number and the communication equipment number is written into the database. Thereafter, the inspection code is reset to a legal user state. The new product registration center is also connected to a software manufacturer system. After the new product registration center has reset the inspection code to a legal user state according to the software serial number and the communication equipment number, the fact that the software has been registered is immediately reported back to the software manufacturer system. If the software serial number is found in the database but the communication equipment number differs from the corresponding communication equipment number in the dataset, the inspection code is reset to an illegal user state.

In the aforementioned method, the inspection code and the communication equipment serial number is transmitted to the new product registration center via a network interface, a wireless communication network or a global positioning system.

In the aforementioned method, the new product registration center is connected to a software manufacturer system. After the new product registration center has reset the inspection code to a legal user state according to the software serial number and the communication equipment number, the fact that the software has been registered is immediately reported back to the software manufacturer system.

This invention also provides a computer system capable of detecting the illegal loading of any software having a software serial number into a computer and executing the software thereafter. The computer system includes a microprocessor, a non-volatile memory unit and a media access controller. The microprocessor is used for generating the inspection code in the process of installing the software into the computer. The non-volatile memory unit is coupled to the microprocessor for holding the inspection code. The media access controller is coupled to the non-volatile memory unit and the communication control interface for transmitting the inspection code to the new product registration center via the communication control interface. According to the software serial number and the communication equipment number, the new product registration center resets the inspection code. Before the computer is able to execute the software program, the program will first check the inspection code. If the inspection code is set to a legal user state, program execution is continued. On the other hand, if the inspection code is found to be in an illegal user state, program execution is immediately terminated.

In the aforementioned embodiment, the communication control interface comprises a network interface card, a wireless communication network or a global positioning system.

The aforementioned non-volatile memory unit can be an erasable programmable read-only-memory (EPROM), an electrically erasable programmable read-only-memory (EEPROM) or a flash memory.

This invention also provides a software registration center suitable for associating with a hardware method of detecting the illegal loading of any software having a software serial number into a computer and executing the software thereafter. The software registration center includes a database. The database includes a plurality of datasets. After transmitting a software serial number and a communication equipment number corresponding to the computer to the software registration center, the serial number and the communication equipment number will be compared with the datasets in the database. According to the software serial number and the communication equipment number, the inspection code stored inside the computer is reset. Before the computer is able to execute the software program, the program will first check the inspection code. If the inspection code is set to a legal user state, program execution will continue. On the other hand, if the inspection code is found to be in an illegal user state, program execution will terminate immediately.

In the aforementioned embodiment, when the software registration center receives a software serial number and a communication equipment number, the serial number and the communication equipment number will be compared with the datasets in the database. If a software serial number and a communication equipment number identical to the submitted serial number and communication equipment number are not found within the database, a new dataset corresponding to the software serial number and the communication equipment number is written into the database. Thereafter, the inspection code is reset to a legal user state. The software registration center is connected to a software manufacturer system. After the software registration center has reset the inspection code to a legal user state according to the software serial number and the communication equipment number, the fact that the software has been registered is immediately reported back to the software manufacturer system. If the software serial number is found in the database but the communication equipment number differs from the corresponding communication equipment number in the dataset, the inspection code is reset to an illegal user state.

In the aforementioned method, the inspection code and the communication equipment serial number is transmitted to the software registration center via a network interface, a wireless communication network or a global positioning system.

In the aforementioned method, the software registration center is connected to a software manufacturer system. After the software registration center has reset the inspection code to a legal user state according to the software serial number and the communication equipment number, the fact that the software has been registered center is immediately reported back to the software manufacturer system.

In this invention, a hardware system and method is used to detect any illegal loading of software into a computer. This prevents anyone from employing various technical means to use the software illegally without paying an authorization fee. In other words, the intellectual property of a software vendor is better protected.

This invention also provides a hardware system and method not only to prevent any illegal loading of software into a computer, but also reports immediately to a software manufacturer when such illegal loading occurs. Thus, an additional layer of intellectual property protection is provided.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a computer system having a personal identity circuit and some associated external installations according to one preferred embodiment of this invention.

FIG. 2 is a table showing exemplary datasets stored inside a database in the new product registration center of the system in FIG. 1.

FIG. 3 is a flow chart showing the steps in a method of detecting any illegal loading of software through the application of a personal identity circuit according to one preferred embodiment of this invention.

FIG. 4 is a flow chart showing the steps to be executed before a user is permitted to execute a software program according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

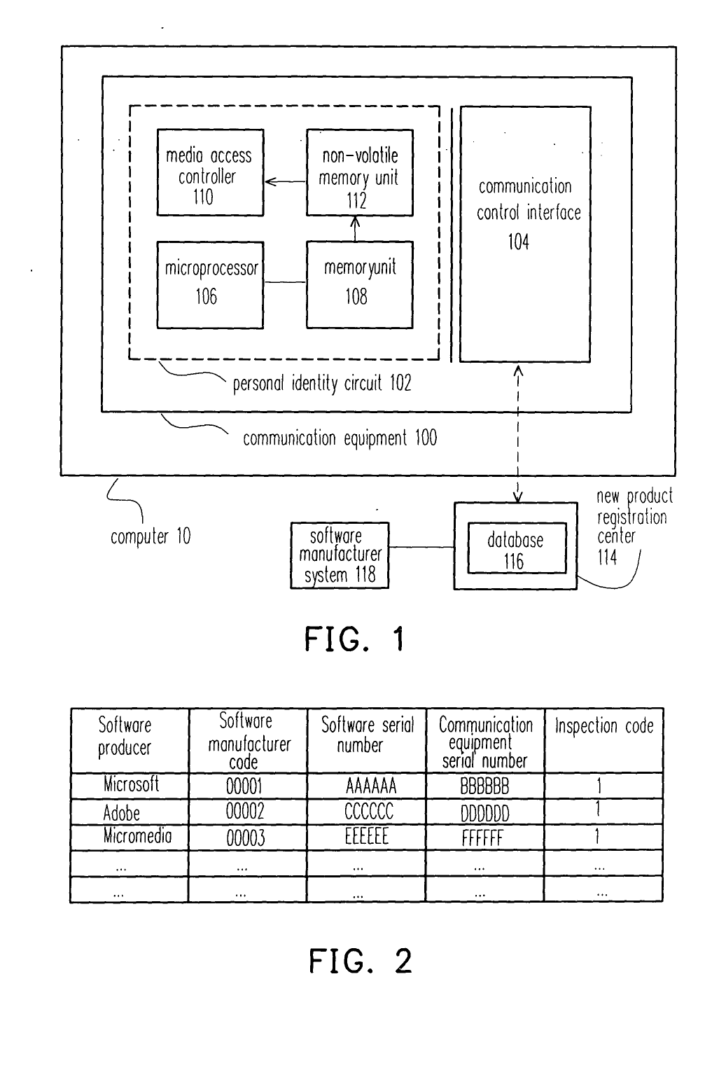

FIG. 1 is a diagram showing a computer system having a personal identity circuit and some associated external installations according to one preferred embodiment of this invention. As shown in FIG. 1, the computer system 10 includes a hardware installation 100 for detecting any illegal loading of software into the computer. The installation 100 further comprises a personal identity circuit 102 and a communication control interface 104. The communication control interface 104 is a medium for the personal identity circuit 102 to communicate with other external devices. The means of communication between the communication control interface 104 and the external devices include a wireless communication network, a cable communication network or other data transmission channels.

The personal identity circuit 102 at least includes a microprocessor 106, a memory unit 108, a media access controller 110 and a non-volatile memory unit 112. In FIG. 1, the memory unit 108 is coupled to the microprocessor 106. In another embodiment, the memory unit 108 can be a built-in memory unit within the microprocessor 106. The microprocessor 106 is capable of generating an inspection code in the process of installing a software program inside the computer. The non-volatile memory unit 112 is capable of holding the software serial number (S/N) of and the inspection code generated by the microprocessor 106 when the software program needs to be installed.

In FIG. 1, the memory unit 108 can be an erasable programmable read-only-memory (EPROM), an electrically erasable programmable read-only-memory (EEPROM), a flash memory, a static random-access-memory (SRAM) or a dynamic random-access-memory (DRAM), for example. Similarly, the non-volatile memory unit 112 can be a flash memory, an erasable programmable read-only-memory (EPROM) or an electrically erasable programmable read-only-memory (EEPROM). The communication control interface 104 in this preferred embodiment can be network interface equipment. In an alternative embodiment, the communication control interface 104 can be a wireless communication network or a global positioning network.

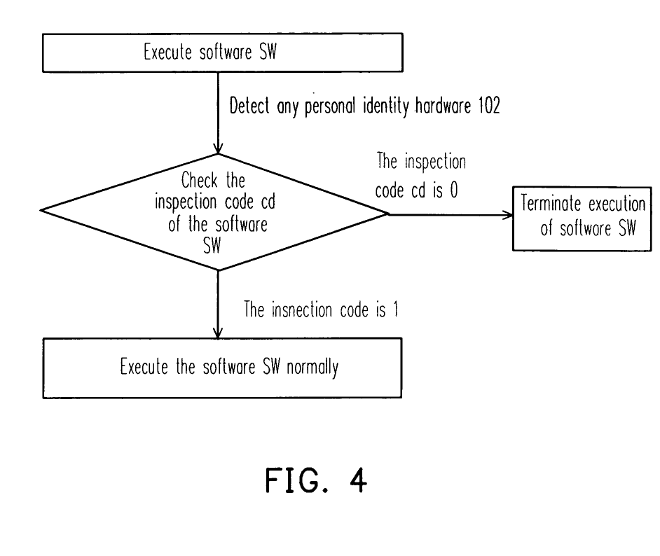

The personal identity circuit 102 is a hardware device for detecting any illegal loading of software programs. When the computer attempts to install and execute a software program having a software serial number S/N, the installation will immediately terminate if the personal identity circuit 102 is not found. However, if the presence of the personal identity circuit 102 is detected, the computer is permitted to install the software program. The software serial number S/N is transferred to the personal identity circuit 102 for storage. In the meantime, an inspection code is generated (in one embodiment, the initial value of the inspection code is 1). FIG. 4 is a flow chart showing the steps to be executed before a user is permitted to execute a software program according one preferred embodiment of this invention. As shown in FIG. 4, before a user is permitted to use the software program (SW), the program will first link up with the personal identity circuit 102 and check out the value of the stored inspection code cd. If the inspection code cd has the value 1, normal execution of the program is allowed. Conversely, if the inspection code cd has a value 0, the program will immediately terminate. The setting of this inspection code cd is explained in more detail below.

Aside from the installation 100, the system for detecting illegal software loading further comprises a new product registration center 114. The new product registration center 114 has a database 116. The new product registration center 114 is linked to the installation 100 via the communication control interface 104. The type of linkage includes a network interface card, a wireless communication network interface card or a global positioning system. Furthermore, the new production registration center 114 may link up with a software manufacturer system 118 via a channel so that data can be transferred between the two. For example, registered data of various software users or any information regarding any abnormal conditions can be transmitted through the channel to prevent any illegal user from using any software programs.

FIG. 2 is a table showing exemplary datasets stored inside a database in the new product registration center of the system in FIG. 1. As shown in FIG. 2, the database 116 has a plurality of datasets. Each dataset contains a list of data including a software manufacturer code, a software serial number, a communication equipment serial number and an inspection code. The new product registration center 114 is connected to the computer via the communication control interface 104 and the software manufacturer system 118 as well.

After completing a software installation to the computer, a software serial number S/N, a communication equipment serial number S1 and an inspection code cd is transmitted to the new product registration center 114 via the communication control interface 104. The communication equipment serial number S1 is a tag for identifying the submitting computer. In general, if the communication control interface 104 is a network card interface, the communication equipment serial number S1 is preferably the serial number of a network card. If the communication control interface 104 is a wireless communication network interface, the serial number S1 is preferably the serial number of a wireless network card. If the communication control interface 104 is linked through a global positioning system, the serial number S1 is the serial number for identifying the location of the communication control interface 104. Obviously, the communication equipment serial number S1 can also be a specially defined computer serial number.

If the software serial number S/N is not yet included within any one of the datasets within the database 116, a new software user registration program is initiated. In the registration program, the new product registration center 114 selects a software manufacturer code according to the software SW. Thereafter, the software manufacturer code together with the software serial number S/N, the communication equipment serial number S1 and the inspection code cd are written down as a new dataset in the database 116 with the inspection code set to the value 1 or a legal software user state.

If the software serial number S/N has already been included in one of the datasets within the database 116 but the communication equipment serial number S1 differs from the equipment serial number within the dataset, the new product registration center 114 will reset the inspection code cd to 0. Before a user is able to use the installed software program, the program will first link up with the personal identity circuit 102 and check for the value of the inspection code cd. If the inspection code cd has a value of 1, program execution will proceed as usual. On the other hand, if the inspection code cd has a value of 0, program execution will terminate immediately.

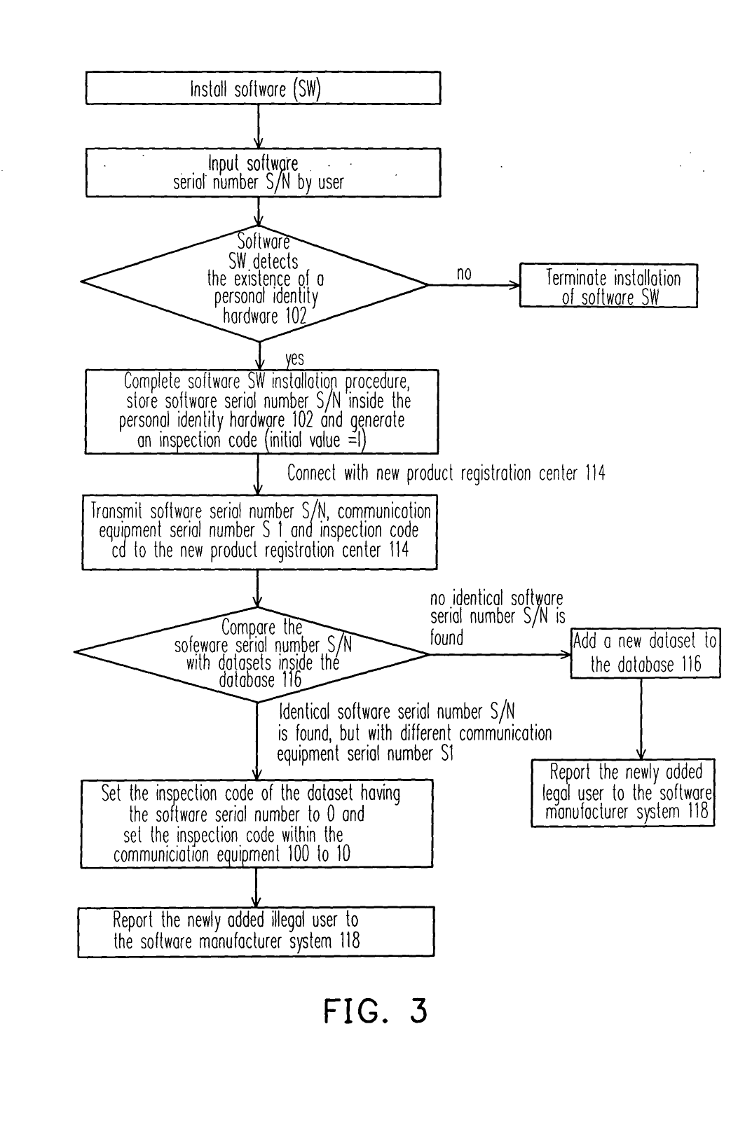

FIG. 3 is a flow chart showing the steps in a method of detecting any illegal loading of software through the application of a personal identity circuit according to one preferred embodiment of this invention. First, as shown in FIG. 3, this invention provides a method of detecting any illegal loading of software invoking a personal identity circuit in a system as shown in FIG. 1. The system is capable of determining if the installation of a software program SW having a serial number S/N into a computer is legal or illegal. The installation 100 comprises a personal identity circuit 102 and a communication control interface 104 with a communication equipment serial number S1. The system furthermore includes a new product registration center 114 with a database 116. In one selected embodiment, the system may also include a software manufacturer system 118. The computer is connected to the new product registration center 114 via the installation 100 and the new product registration center 114 is connected to the software manufacturer system 118. The database 116 has a plurality of datasets as shown in FIG. 2. Each dataset stores up a list of data including a software manufacturer code, a software serial number, a communication equipment serial number and an inspection code. The method of using the personal identity circuit 102 to detect any illegal loading of software includes the following steps.

Before installing the software program SW into the computer, a software serial number S/N is requested. The software SW will transmit the serial number S/N to the communication installation 100. If the software SW is somehow prevented from connecting to the personal identity circuit 102 inside the communication equipment 100 or the communication equipment 100 does not have a personal identity circuit 102, the software SW terminates the installation procedure. If the software SW is able to connect with the personal identity circuit 102 inside the communication equipment 100, the following steps are carried out.

The software SW initiates the transmission of the serial number S/N to the personal identity circuit 102 for storage, completes the installation procedure, generates an inspection code cd (with initial value set to 1). Thereafter, the software SW triggers the communication equipment 100 to transmit the software serial number S/N, the communication equipment number S1 of the communication equipment 100 and the inspection code cd to the new product registration center 114.

The new product registration center compares the newly received software serial number S/N and the communication equipment serial number S1 with the software serial number and the communication equipment serial number residing within each dataset of the database 116. If the software serial number S/N cannot be found within any one of the datasets within the database 116, the new product registration center will execute a registration program. In the registration program, a software manufacturer code is selected according to the software SW and then the software manufacturer code together with the submitted software serial number S/N, the communication equipment serial number S1 and the inspection code cd are written into a new dataset. Thereafter, the new product registration center will link up with the software manufacturer system 118 and report the new registration.

If the software serial number S/N is found among the datasets within the database 116 but the communication equipment number S1 within the dataset differs from the one within the dataset, the new product registration center 114 will reset the value of the inspection code cd to 0. Thereafter, the new product registration center 114 also re-transmits the zero value back to the communication equipment 100 so that the inspection code cd inside the communication equipment 100 is also reset to zero. In the meantime, the new product registration center 114 also reports back to the software manufacturer system 118 about such illegal attempt at loading their software program.

FIG. 4 shows a user executing a program PR for loading and using a software SW with an illegal loading detection system according to this invention. When the computer execute the program PR, the program PR will link up with the personal identity circuit 102 and check the value of the inspection code cd. If the inspection code cd is found to be 1, program execution will continue normally. Conversely, if the inspection code cd is found to be 0, program execution will terminate immediately.

In the aforementioned method, the inspection code and the communication equipment serial number of the computer are transmitted to the new product registration center via a network interface, a wireless communication network or a global positioning system.

Furthermore, the new product registration center is also connected to a software manufacturer system. After the new product registration center resets the inspection code to a legal user state according to the software serial number and the communication equipment number, the fact that the software has been registered is also immediately reported back to the software manufacturer system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A system for detecting an illegal loading of a software with a software serial number and executing the software thereafter, the system comprising:
a personal identity circuit for holding a software serial number of a software and generating an inspection code in installing the software; and
a communication control interface having a communication equipment serial number, the communication control interface is provided for connecting the personal identity circuit with a new product registration center, therefore the new product registration center reset the inspection code according to the software serial number and the communication equipment serial number;
wherein the software automatically checks the inspection code before executing the software, when the inspection code is in a legal user state, executing of the software permitted, when the inspection code is in an illegal user state, executing of the software is terminated immediately.

2. The system of claim 1, wherein the new product registration center further comprises a database having a plurality of datasets, when the software serial number and the communication equipment serial number is received by the new product registration center, the software serial number and the communication equipment serial number are compared with the the datasets, when identical software serial number and communication equipment serial number is not found among the datasets, the software serial number and the communication equipment serial number are written down as a new dataset in the database and then the inspection code is reset to the legal user state.

3. The system of claim 2, wherein the new product registration center is connected to a software manufacturer system for reporting a software registration to the software manufacturer system after the new product registration center reset the inspection code to the legal user state according to the software serial number and the communication equipment serial number.

4. The system of claim 1, wherein the new product registration center further comprises a database having a plurality of datasets, when the software serial number and the communication equipment serial number is received by the new product registration center, the software serial number and the communication equipment serial number are compared with the datasets, when the software serial number is found within one of the datasets but a communication equipment serial number in the one of the datasets differs from the received communication equipment serial number, the inspection code is reset to the illegal user state.

5. The system of claim 1, wherein the communication control interface comprises a network interface card.

6. The system of claim 1, wherein the communication control interface comprises a wireless communication network.

7. The system of claim 1, wherein the communication control interface comprises a global positioning system.

8. The system of claim 1, wherein the new product registration center is connected to a software manufacturer system for reporting a software registration to the software manufacturer system after the new product registration center reset the inspection code to the legal user state according to the software serial number and the communication equipment serial number.

9. The system of claim 1, wherein the personal identity circuit further comprises:
a microprocessor having a memory unit for generating the inspection code when installing the software;
a non-volatile memory unit coupled to the microprocessor for holding the inspection code; and
a media access controller coupled to the non-volatile memory unit and the communication control interface for transmitting the inspection code to the new product registration center via the communication control interface.

10. The system of claim 9, wherein the memory unit comprises an erasable programmable read-only-memory.

11. They system of claim 9, wherein the memory unit comprises an electrically erasable programmable read-only-memory.

12. The system of claim 9, wherein the memory unit comprises a flash memory.

13. The system of claim 9, wherein the memory unit comprises a static random access memory.

14. The system of claim 9, wherein the memory unit comprises a dynamic random access memory.

15. The system of claim 9, wherein the non-volatile memory unit comprises an erasable programmable read-only-memory.

16. The system of claim 9, wherein the non-volatile memory unit comprises an electrically erasable read-only-memory.

17. The system of claim 9, wherein the non-volatile memory comprises a flash memory.

18. The system of claim 1, wherein the personal identity circuit further comprises:
a microprocessor having a memory unit for generating the inspection code when installing the software;
a non-volatile memory unit coupled to the microprocessor for holding the inspection code; and
a media access controller coupled to the non-volatile memory unit and the communication control interface for transmitting the inspection code to the new product registration center via the communication control interface.

19. A chip in a system for detecting an illegal loading of a software with a software serial number and executing the software thereafter, the chip comprising:
a microprocessor for generating an inspection code when installing a software having a software serial number;
a non-volatile memory unit coupled to the microprocessor for holding the inspection code; and
a media access controller coupled to the non-volatile memory unit and a communication control interface for transmitting the inspection code and a communication equipment serial number to a new product registration center via the communication control interface such that the new product registration center resets the inspection code according to the received software serial number and the communication equipment serial number, wherein the software automatically checks the inspection code before executing the software, when the inspection code is in a legal user state, executing of the software is permitted, when the inspection code is in an illegal user state, executing of the software is terminated immediately.

20. The chip of claim 19, wherein the communication control interface comprises a network interface card.

21. The chip of claim 19, wherein the communication control interface comprises a wireless communication network.

22. The chip of claim 19, wherein the communication control interface comprises a global positioning system.

23. The chip of claim 19, wherein the non-volatile memory unit comprises an erasable programmable read-only-memory.

24. They chip of claim 19, wherein the non-volatile memory unit comprises an electrically erasable programmable read-only-memory.

25. The chip of claim 19, wherein the non-volatile memory unit comprises a flash memory.

26. A method of using hardware to detect an illegal loading of a software with a software serial number and executing the software thereafter, comprising:
writing down a software serial number and generating an inspection code when installing a software into a computer; and
transmitting the inspection code and a communication equipment serial number of the computer to a new product registration center;
wherein the new product registration center resets the inspection code according to the received software serial number and the communication equipment serial number, before the computer is able to execute the software, the software automatically checks the inspection code, when the inspection code is in a legal user state, executing of the software is permitted, when the inspection code is in an illegal user state, executing of the software is terminated immediately.

27. The method of claim 26, wherein the new product registration center further comprises a database having a plurality of datasets, when the software serial number and the communication equipment serial number is received by the new product registration center, the software serial number and the communication equipment serial number are compared with the datasets, when identical software serial number and communication equipment serial number are not found among the datasets, the software serial number and the communication equipment serial number are written down as a new dataset in the database and then the inspection code is reset to the legal user state.

28. The method of claim 27, wherein the new product registration center is connected to a software manufacturer system for reporting a registration of software to the software manufacturer system after the new product registration center resets the inspection code to the legal user state according to the software serial number and the communication equipment serial number.

29. The method of claim 26, wherein the new product registration center further comprises a database having a plurality of datasets, when the software serial number and the communication equipment serial number is received by the new product registration center, the software serial number and the communication equipment serial number are compared with the datasets, when the software serial number is found within one of the database but a communication equipment serial number in the one of the dataset differs from the received communication equipment serial number, the inspection code is reset to the illegal user state.

30. The method of claim 26, wherein the inspection code and the communication equipment serial number of the computer are transmitted to the new product registration center through a network interface.

31. The method of claim 26, wherein the inspection code and the communication equipment serial number of the computer are transmitted to the new product registration center through a wireless communication network.

32. The method of claim 26, wherein the inspection code and the communication equipment serial number of the computer are transmitted to the new product registration center through a global positioning system.

33. The method of claim 26, wherein the new product registration center is connected to a software manufacturer system for reporting a registration of software to the software manufacturer system after the new product registration center resets the inspection code to the legal user state according to the software serial number and the communication equipment serial number.

34. A computer system for detecting an illegal loading of a software with a software serial number into the computer system and executing the software thereafter, the computer system comprising:
a microprocessor for generating an inspection code when installing the software to the computer system;
a non-volatile memory coupled to the microprocessor for holding the inspection code; and
a media access controller coupled to the non-volatile memory unit and a communication control interface for transmitting the inspection code and a communication equipment serial number to the new product registration center via the communication control interface such that the new product registration center resets the inspection code according to the received software serial number and the communication equipment serial number, wherein the software automatically checks the inspection code before executing the software, when the inspection code is in a legal user state, executing of the software is permitted, when the inspection code is in an illegal user state, executing the software is terminated immediately.

35. The computer system of claim 34, wherein the communication control interface comprises a network interface card.

36. The computer system of claim 34, wherein the communication control interface comprises a wireless communication network.

37. The computer system of claim 34, wherein the communication control interface comprises a global positioning system.

38. The computer system of claim 34, wherein the non-volatile memory unit comprises an erasable programmable read-only-memory.

39. They computer system of claim 34, wherein the non-volatile memory unit comprises an electrically erasable programmable read-only-memory.

40. The computer system of claim 34, wherein the memory unit comprises a flash memory.

41. A software registration center linked to a hardware system for detecting an illegal loading of a software with a software serial number into a computer and executing the software thereafter, wherein the software registration center has a database with a plurality of datasets, when the software registration center receives the software serial number and the communication equipment serial number, the software serial number and the communication equipment serial number are compared with the datasets, an inspection code stored in the computer is then reset according to the software serial number and the communication equipment serial number, before the computer is able to execute the software, the software automatically checks the inspection code, when the inspection code is in a legal user state, executing of the software is permitted, when the inspection code is in an illegal user state, executing of the software is terminated immediately.

42. The software registration center of claim 41, wherein the software serial number and the communication equipment serial number received by the software registration center are compared with the datasets, when identical software serial number and communication equipment serial number are not found among the datasets, the software serial number and the communication equipment serial number are written down as a new dataset in the database and then the inspection code is reset to the legal user state.

43. The software registration center of claim 42, wherein the software registration center is connected to a software manufacturer system for reporting an registration of the software to the software manufacturer system after the software registration center resets the inspection code to the legal user state according to the software serial number and the communication equipment serial number.

44. The software registration center of claim 41, wherein the software serial number and the communication equipment serial number received by the software registration center are compared with the datasets of the database, when the software serial number is found within one of the database but a communication equipment serial number in the one of the dataset differs from the received communication equipment serial number, the inspection code is reset to the illegal user state.

45. The software registration center of claim 41, wherein the inspection code and the communication equipment serial number of the computer are transmitted to the software registration center through a network interface.

46. The software registration center of claim 41, wherein the inspection code and the communication equipment serial number of the computer are transmitted to the software registration center through a wireless communication network.

47. The software registration center of claim 41, wherein the inspection code and the communication equipment serial number of the computer are transmitted to the software registration center through a global positioning system.

48. The software registration center of claim 41, wherein the software registration center is connected to a software manufacturer system for reporting a registration of the software to the software manufacturer system after the software registration center resets the inspection code to the legal user state according to the software serial number and the communication equipment serial number.
